(19) United States
(12) Patent Application Publication
(10) Pub. No.: US 2023/0070909 A1
(43) Pub. Date: Mar. 9, 2023

(54) VEHICLE CONTROL APPARATUS, VEHICLE CONTROL METHOD, AND VEHICLE CONTROL SYSTEM

(71) Applicant: Hitachi Astemo, Ltd., Hitachinaka-shi, Ibaraki (JP)

(72) Inventors: Koki TAKIMOTO, Hitachinaka-shi, Ibaraki (JP); Daisuke GOTO, Hitachinaka-shi, Ibaraki (JP); Takuya USUI, Hitachinaka-shi, Ibaraki (JP)

(21) Appl. No.: 17/799,995

(22) PCT Filed: Jan. 29, 2021
(86) PCT No.: PCT/JP2021/003222

§ 371 Date: Aug. 16, 2022

(30) Foreign Application Priority Data
Feb. 18, 2020 (JP) 2020-025080

(51) Int. Cl. B60T 8/172; B60T 13/74; F16D 65/18; B60T 1/06; F16D 55/226

(52) U.S. Cl. CPC B60T 8/172; B60T 13/74; F16D 65/183; B60T 1/065; F16D 55/226; F16D 2121/24

(57) ABSTRACT

Left front electric brake mechanisms apply a braking force to a left front wheel by actuating an “electric motor of a first left front electric brake mechanism” and an “electric motor of a second left front electric brake mechanism” controllable independently of each other. A first ECU (a control portion) acquires a target thrust force instruction value to be generated on the left front electric brake mechanisms based on a target braking force to be applied to the left front wheel. The first ECU (the control portion) outputs a first control instruction for actuating the electric motor of the first left front electric brake mechanism and a second control instruction for actuating the electric motor of the first left front electric brake mechanism according to a change amount of the target thrust force instruction value.

### TECHNICAL FIELD

The present invention relates to a vehicle control apparatus, a vehicle control method, and a vehicle control system.

### BACKGROUND ART

PTL 1 discusses an electric brake apparatus that thrusts a first piston and a second piston controllable independently of each other to press brake pads against a disk rotor, thereby generating a braking force. This electric brake apparatus alternately or simultaneously actuates the first piston and the second piston.

### CITATION LIST

### Patent Literature

PTL 1: US Patent Application Publication No. 2019/0120311

### SUMMARY OF INVENTION

### Technical Problem

Then, using an electric brake apparatus like PTL 1 to control a vehicle behavior necessitates fine control of the braking force, i.e., accuracy of controlling the thrust force of the piston (a piston thrust force). PTL 1 discloses the technique that alternately or simultaneously actuates the two pistons, but fails to disclose a specific actuation order. Therefore, this technique leaves room for the improvement of the accuracy of controlling the piston thrust force according to how the two pistons are controlled.

An object of one aspect of the present invention is to provide a vehicle control apparatus, a vehicle control method, and a vehicle control system capable of improving accuracy of controlling a thrust force exerted by a first thrust portion and a second thrust portion controllable independently of each other.

### Solution to Problem

According to one aspect of the present invention, a vehicle control apparatus includes a control portion provided to a vehicle including an electric brake mechanism configured to apply a braking force to a wheel of the vehicle by thrusting a thrust portion including a first thrust portion and a second thrust portion controllable independently of each other. The control portion is configured to output a calculation result by making a calculation based on input information. The control portion acquires a target thrust force instruction value to be generated on the thrust portion based on a target braking force to be applied to the wheel, and outputs a first control instruction for actuating the first thrust portion and a second control instruction for actuating the second thrust portion according to a physical amount regarding a change in the target thrust force instruction value.

Further, another aspect of the present invention is a vehicle control method for a vehicle including an electric brake mechanism configured to apply a braking force to a wheel of the vehicle by thrusting a thrust portion including a first thrust portion and a second thrust portion controllable independently of each other. The vehicle control method includes acquiring a target thrust force instruction value to be generated on the thrust portion based on a target braking force to be applied to the wheel, and outputting a first control instruction for actuating the first thrust portion and a second control instruction for actuating the second thrust portion according to a physical amount regarding a change in the target thrust force instruction value.

Further, according to another aspect of the present invention, a vehicle control system includes an electric brake mechanism configured to apply a braking force to a wheel of a vehicle by thrusting a thrust portion including a first thrust portion and a second thrust portion controllable independently of each other, and a controller configured to acquire a target thrust force instruction value to be generated on the thrust portion based on a target braking force to be applied to the wheel and output a first control instruction for actuating the first thrust portion and a second control instruction for actuating the second thrust portion according to a physical amount regarding a change in the target thrust force instruction value.

According to the aspects of the present invention, the accuracy of controlling the thrust force exerted by the first thrust portion and the second thrust portion can be improved.

### BRIEF DESCRIPTION OF DRAWINGS

FIG. 1 is a schematic view illustrating a vehicle on which a vehicle control apparatus and a vehicle control system according to a first embodiment are mounted.

FIG. 2 is a schematic view illustrating an electric brake mechanism on a front wheel side illustrated in FIG. 1 together with a brake disk.

FIG. 3 is a schematic view illustrating an electric brake mechanism on a rear wheel side illustrated in FIG. 1 together with a brake disk.

FIG. 4 is a flowchart illustrating control processing performed by a first ECU and a second ECU illustrate in FIG. 1.

FIG. 5 illustrates characteristic lines indicating examples of changes in a thrust force of a first piston (P1), a thrust force of a second piston (P2), a total thrust force thereof (P1+P2), and an instruction value over time.

FIG. 6 illustrates characteristic lines indicating other examples of the changes in the thrust force of the first piston (P1), the thrust force of the second piston (P2), the total thrust force thereof (P1+P2), and the instruction value over time.

FIG. 7 is a schematic view illustrating a vehicle on which a vehicle control apparatus and a vehicle control system according to a second embodiment are mounted.

FIG. 8 is a flowchart illustrating control processing performed by a first ECU and a second ECU illustrate in FIG. 7.

### DESCRIPTION OF EMBODIMENTS

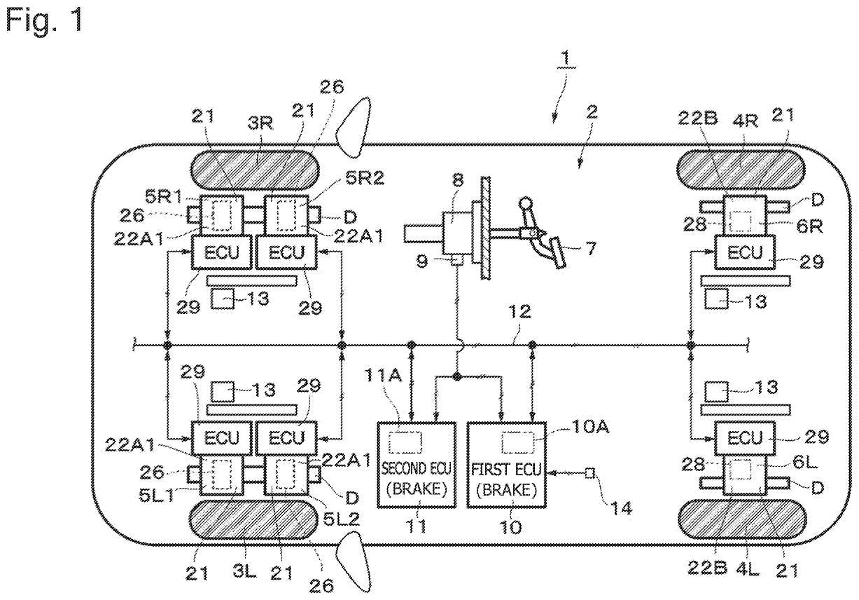

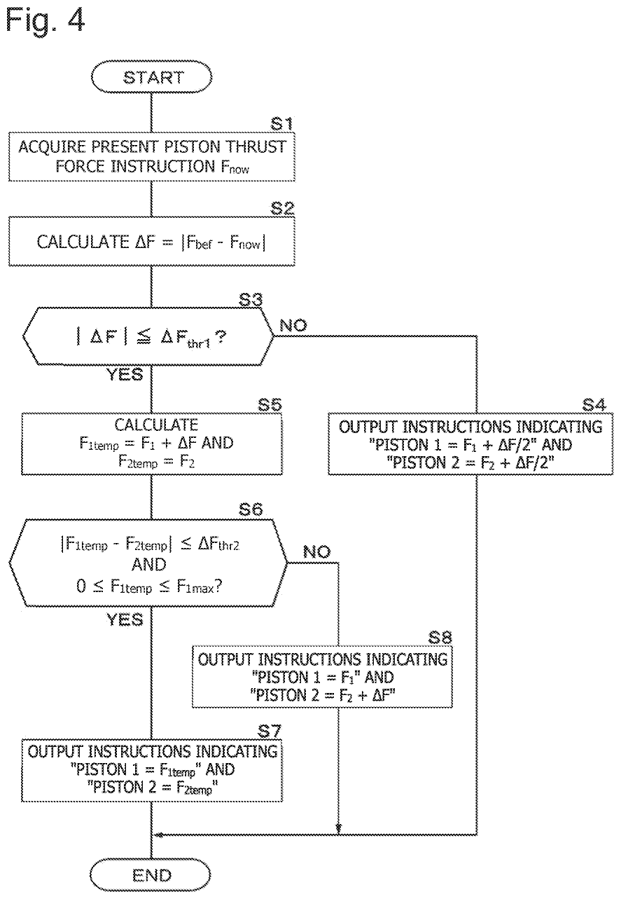

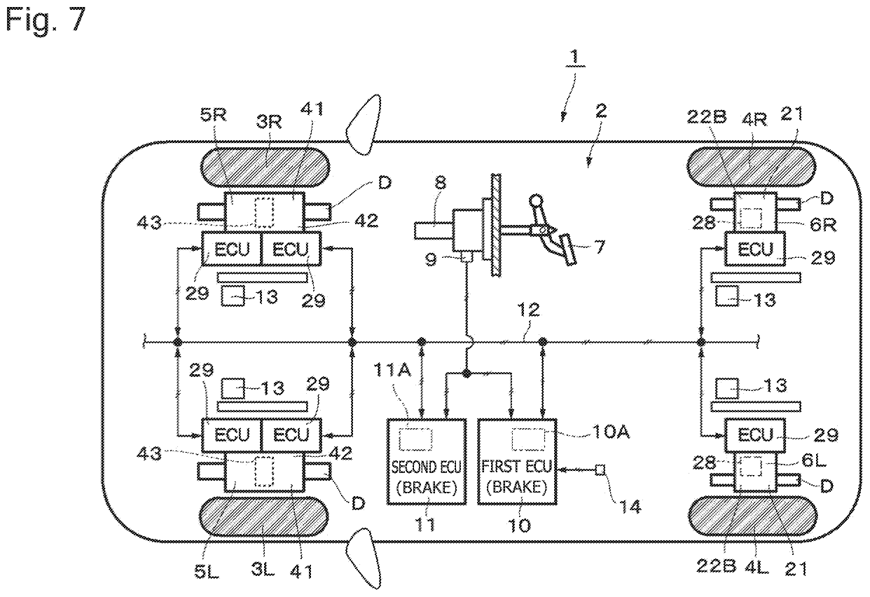

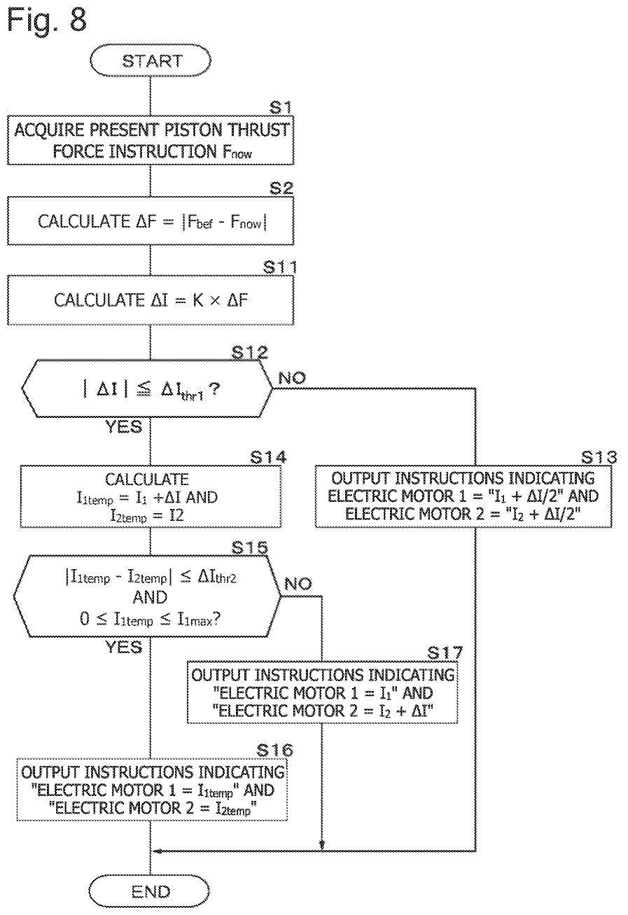

In the following description, a vehicle control apparatus, a vehicle control method, and a vehicle control system according to embodiments will be described citing an example in which they are applied to a four-wheeled automobile with reference to the accompanying drawings. Each of steps in flowcharts illustrated in FIGS. 4 and 8 will be represented by the symbol “S” (for example, assume that step 1 is step 1=“S1”). Further, lines with two slash marks added thereto in FIGS. 1 and 7 indicate electricity-related lines. Further, indexes “L” and “R” correspond to “left” and “right”, respectively.

FIG. 1 illustrates a vehicle system. In FIG. 1, a vehicle 1 is equipped with a brake apparatus 2 (a brake system), which applies braking forces to wheels 3 and 4 (front wheels 3L and 3R and rear wheels 4L and 4R) to brake the vehicle 1. The brake apparatus 2 includes left and right front wheel-side electric brake mechanisms 5L1, 5L2, 5R1, and 5R2 (front braking mechanisms) provided in correspondence with a left-side front wheel 3L (a left front wheel 3L) and a right-side front wheel 3R (a right front wheel 3R), left and right rear wheel-side electric brake mechanisms 6L and 6R (rear braking mechanisms) provided in correspondence with a left-side rear wheel 4L (a left rear wheel 4L) and a right-side rear wheel 4R (a right rear wheel 4R), a brake pedal 7 (an operation tool) as a brake operation member, a pedal reaction force device 8 (hereinafter referred to as a pedal simulator 8) that generates a kickback reaction force according to an operation (pressing) on the brake pedal 7, and a pedal stroke sensor 9 as an operation detection sensor that measures an amount of an operation performed by a driver (an operator) on the brake pedal 7.

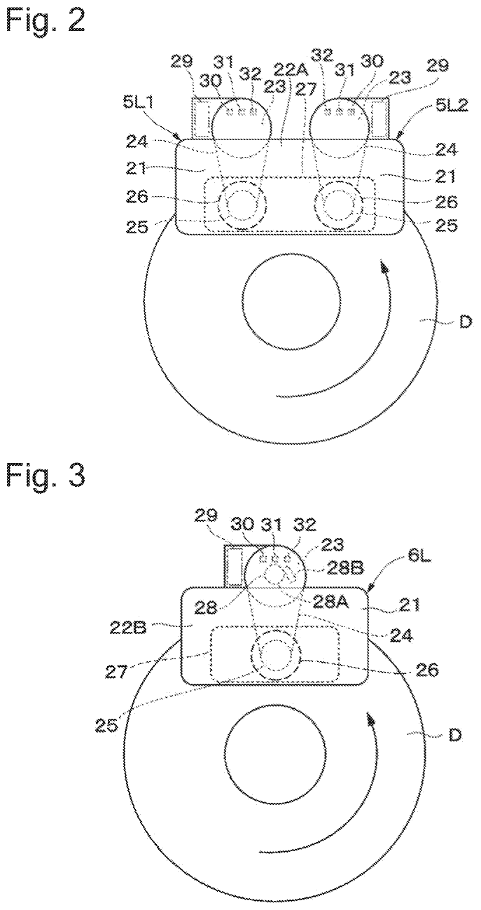

The left and right front wheel-side electric brake mechanisms 5L1, 5L2, 5R1, and 5R2 and the left and right rear wheel-side electric brake mechanisms 6L and 6R (hereinafter also referred to as electric brake mechanisms 5 and 6) are each formed by, for example, an electric disk brake. In other words, the electric brake mechanisms 5 and 6 apply braking forces to the wheels 3 and 4 (the front wheels 3L and 3R and the rear wheels 4L and 4R) based on driving of electric motors 23 (refer to FIGS. 2 and 3). In this case, the left and right rear wheel-side electric brake mechanisms 6L and 6R each include a parking mechanism 28.

The pedal stroke sensor 9 is provided on, for example, the pedal simulator 8. The pedal stroke sensor 9 may be provided on the brake pedal 7. Further, a pressing force sensor that measures a pressing force corresponding to the amount of the operation on the brake pedal 7 may be used instead of the pedal stroke sensor 9. The pedal stroke sensor 9 is connected to a first brake control ECU 10 and a second brake control ECU 11, each of which is an ECU (Electronic Control Unit) for brake control. The first brake control ECU 10 (also referred to as the first ECU 10) and the second brake control ECU 11 (also referred to as the second ECU 11) are provided to the vehicle 1. The first ECU 10 and the second ECU 11 each include a microcomputer equipped with an arithmetic processing unit (a CPU), a storage device (a memory), a control board, and the like, and correspond to a vehicle control apparatus and a controller. The first ECU 10 and the second ECU 11 calculate a braking force (a target barking force) for each of the wheels (the four wheels) according to a predetermined control program in reaction to an input of a signal from the pedal stroke sensor 9.

The first ECU 10 calculates, for example, a target braking force that should be applied to the left-side front wheel 3L and the right-side rear wheel 4R. The first ECU 10 outputs (transmits) a braking instruction directed to each of the two wheels, the left-side front wheel 3L and the right-side rear wheel 4R to the electric brake ECUs 29 and 29 via a CAN 12 (Control Area Network) serving as a vehicle data bus based on the calculated target braking force. The second ECU 11 calculates, for example, a target braking force that should be applied to the right-side front wheel 3R and the left-side rear wheel 4L. The second ECU 11 outputs (transmits) a braking instruction directed to each of the two wheels, the right-side front wheel 3R and the left-side rear wheel 4L to the electric brake ECUs 29 and 29 via the CAN 12 based on the calculated target braking force. To perform such control regarding braking, the first ECU 10 and the second ECU 11 include control portions 10A and 11A, which make a calculation based on input information (for example, the signal from the pedal stroke 9) to output a calculation result (for example, a control instruction according to a target thrust force).

Wheel speed sensors 13 and 13 are provided near the front wheels 3L and 3R and the rear wheels 4L and 4R, respectively. The wheel speed sensors 13 and 13 detect the speeds of these wheels 3L, 3R, 4L, and 4R (wheel speeds). The wheel speed sensors 13 and 13 are connected to the first ECU 10 and the second ECU 11. The first ECU 10 and the second ECU 11 can acquire the wheel speed of each of the wheels 3L, 3R, 4L, and 4R based on a signal from each of the wheel speed sensors 13 and 13. Further, the first ECU 10 and the second ECU 11 receive vehicle information transmitted from another ECU mounted on the vehicle 1 (for example, a prime mover ECU, a transmission ECU, a steering ECU, or an autonomous driving ECU, which are not illustrated) via the CAN 12. For example, the first ECU 10 and the second ECU 11 can acquire various kinds of vehicle information such as information about the position of the automatic transmission range or the position of the manual transmission shift, information about ON/OFF of the ignition, information about the engine speed, information about the power train torque, information about the transmission gear ratio, information about an operation on the steering wheel, information about a clutch operation, information about an accelerator operation, information about inter-vehicle communication, information about surroundings around the vehicle that is acquired by an in-vehicle camera, and information about the acceleration sensor (the longitudinal acceleration and the lateral acceleration) via the CAN 12.

Further, a parking brake switch 14 is provided near the driver's seat. The parking brake switch 14 is connected to the first ECU 10 (and the second ECU 11 via the CAN 12). The parking brake switch 14 transmits a signal (an actuation request signal) corresponding to a request to actuate the parking brake (an application request working as a holding request or a release request working as an end request) according to an operation instruction from the driver to the first ECU 10 and the second ECU 11. The first ECU 10 and the second ECU 11 transmit a parking brake instruction directed to each of the rear two wheels to each of the electric brake ECUs 29 and 29 based on an operation on the parking brake switch 14 (the actuation request signal). The parking brake switch 14 corresponds to a switch that actuates the parking mechanism 28.

As illustrated in FIGS. 1 and 2, the left and right front wheel-side electric brake mechanisms 5L1, 5L2, 5R1, and 5R2 (hereinafter also referred to as the electric brake mechanisms 5) are formed by two electric brake mechanisms for each of the left side and the right side. More specifically, the left front-side electric brake mechanisms 5L1 and 5L2 include the first left front electric brake mechanism 5L1 and the second left front electric brake mechanism 5L2, and the right front-side electric brake mechanisms 5R1 and 5R2 include the first right front electric brake mechanism 5R1 and the second right front electric brake mechanism 5R2.

The first left front electric brake mechanism 5L1 includes a brake mechanism 21, an electric motor 23, and the electric brake ECU 29. The second left front electric brake mechanism 5L2 also includes the brake mechanism 21, the electric motor 23, and the electric brake ECU 29. In this case, the first left front electric brake mechanism 5L1 and the second left front electric brake mechanism 5L2 may be configured integrally using a common caliper 22A as illustrated in FIG. 2 or may be configured individually separately using different calipers 22A1 and 22A1 as illustrated in FIG. 1. Further, the first right front electric brake mechanism 5R1 also includes the brake mechanism 21, the electric motor 23, and the electric brake ECU 29. The second right front electric brake mechanism 5R2 also includes the brake mechanism 21, the electric motor 23, and the electric brake ECU 29. In this case, the first right front electric brake mechanism 5R1 and the second right front electric brake mechanism 5R2 may also be configured integrally using the common caliper 22A as illustrated in FIG. 2 or may be configured individually separately using the different calipers 22A1 and 22A1 as illustrated in FIG. 1.

On the other hand, as illustrated in FIGS. 1 and 3, the left and right rear wheel-side electric brake mechanisms 6L and 6R (hereinafter also referred to as the electric brake mechanisms 6) are formed by one electric brake mechanism for each of the left side and the right side. More specifically, the left rear electric brake mechanism 6L includes the brake mechanism 21, the electric motor 23, the parking mechanism 28 as a braking force holding mechanism, and the electric brake ECU 29. The right rear electric brake mechanism 6R includes the brake mechanism 21, the electric motor 23, the parking mechanism 28 as the braking force holding mechanism, and the electric brake ECU 29. The electric brake mechanisms 6 on the rear wheel 4L and 4R side are different from the electric brake mechanisms 5 on the front wheel 3L and 3R side in terms of being each formed by one electric brake mechanism and including the parking mechanism 28.

The electric brake mechanisms 5 and 6 each control the position and the thrust force of the brake mechanism 21. To achieve this control, as illustrated in FIG. 2, the brake mechanism 21 includes a rotational angle sensor 30, a thrust force sensor 31, and a current sensor 32. The rotational angle sensor 30 serves as a position detector that detects a motor rotational position. The thrust force sensor 31 serves as a thrust force detector that detects the thrust force (the piston thrust force). The current sensor 32 serves as a current detector that detects a motor current.

The electric motor 23 is provided to the brake mechanism 21. The brake mechanism 21 includes, for example, the front wheel-side caliper 22A (22A1) or a rear wheel-side caliper 22B as a cylinder (a wheel cylinder), a piston 26 as a pressing member, and brake pads 27 as a braking member (pads) as illustrated in FIGS. 2 and 3. Further, the brake mechanism 21 includes the electric motor 23 as an electric motor (an electric actuator), a speed reduction mechanism 24, a rotation-linear motion conversion mechanism 25, and a not-illustrated fail-open mechanism (a return spring). The electric motor 23 is driven (rotated) according to the supply of electric power thereto, and thrusts the piston 26. By this operation, the electric motor 23 provides the braking force. The electric motor 23 is controlled by the electric brake ECU 29 based on the braking instruction from the first ECU 10 or the second ECU 11. The speed reduction mechanism 24 is formed by, for example, a gear speed reduction mechanism, and transmits the rotation of the electric motor 23 to the rotation-linear motion conversion mechanism 25 while slowing down it.

The rotation-linear motion conversion mechanism 25 converts the rotation of the electric motor 23 transmitted via the speed reduction mechanism 24 into an axial displacement of the piston 26 (a linear-motion displacement). The piston 26 is thrust due to the driving of the electric motor 23, and moves the brake pads 27. The brake pads 27 are pressed against a disk rotor D as a braking receiving member (a disk) by the piston 26. The disk rotor D rotates together with the wheel 3L, 3R, 4L, or 4R. When the braking is applied, the not-illustrated return spring (the fail-open mechanism) applies a rotational force to a rotational member of the rotation-linear motion conversion mechanism 25 in a braking release direction. In the brake mechanism 21, the piston 26 is thrust so as to press the brake pads 27 against the disk rotor D due to the driving of the electric motor 23. In other words, the brake mechanism 21 transmits the thrust force generated due to the driving of the electric motor 23 to the piston 26, which moves the brake pads 27, based on the braking request (the braking instruction).

As illustrated in FIG. 1, the parking mechanism 28 is provided to each of the brake mechanism 21 on the left side (more specifically, the left rear wheel 4L side) and the brake mechanism 21 on the right side (more specifically, the right rear wheel 4R side). The parking mechanism 28 keeps the piston 26 of the brake mechanism 21 in the thrust state. In other words, the parking mechanism 28 holds and releases the braking force. The parking mechanism 28 maintains the braking force by engaging a part of the brake mechanism 21. The parking mechanism 28 is formed by, for example, a ratchet mechanism (a lock mechanism), which prohibits (locks) the rotation by engaging (hooking) an engagement claw 28B (a lever member) with a ratchet 28A (a ratchet gear), as illustrated in FIG. 3. In this case, the engagement claw 28B is engaged with the ratchet 28A due to, for example, driving of a solenoid (not illustrated) controlled by the first ECU 10, the second ECU 11, and the electric brake ECU 29. As a result, the rotation of the rotational shaft of the electric motor 23 is prohibited and the braking force is maintained.

As illustrated in FIGS. 1 to 3, the electric brake ECU 29 is provided in correspondence with each of the brake mechanisms 21, i.e., each of the brake mechanisms 21 and 21 on the left front wheel 3L side, the brake mechanisms 21 and 21 on the right front wheel 3R side, the brake mechanism 21 on the left rear wheel 4L side, and the brake mechanism 21 on the right rear wheel 4R side. The electric brake ECU 29 includes a microcomputer and a driving circuit (for example, an inverter). The electric brake ECU 29 controls the brake mechanism 21 (the electric motor 23) based on an instruction from the first ECU 10 or the second ECU 11. Further, the electric brake ECU 29 on the rear wheel side also controls the parking mechanism 28 (the solenoid) based on an instruction from the first ECU 10 or the second ECU 11. In other words, the electric brake ECU 29 forms a control apparatus (a brake control apparatus) that controls the actuation of the electric motor 23 (and the parking mechanism 28) together with the first ECU 10 and the second ECU 11. In this case, the electric brake ECU 29 controls the driving of the electric motor 23 based on the braking instruction. Further, the electric brake ECU 29 on the rear wheel side controls the driving of the parking mechanism 28 (the solenoid) based on the actuation instruction. A signal corresponding to the braking instruction or a signal corresponding to the actuation instruction from the first ECU 10 or the second ECU 11 is input to the electric brake ECU 29.

As illustrated in FIGS. 2 and 3, the rotational angle sensor 30 detects the rotational angle of the rotational shaft of the electric motor 23 (a motor rotational angle). The rotational angle sensor 30 is provided in correspondence with each of the respective electric motors 23 of the brake mechanisms 21, and forms the position detector that detects the rotational position of the electric motor 23 (the motor rotational position) and thus the piston position. The thrust force sensor 31 detects a reaction force to the thrust force (the pressing force) applied from the piston 26 to the brake pads 27. The thrust force sensor 31 is provided to each of the brake mechanisms 21, and forms the thrust force detector that detects the thrust force working on the piston 26 (the piston thrust force). The current sensor 32 detects a current supplied to the electric motor 23 (the motor current). The current sensor 32 is provided in correspondence with each of the respective electric motors 23 of the brake mechanisms 21, and forms the current detector that detects the motor current (a motor torque current) of the electric motor 23. The rotational angle sensor 30, the thrust force sensor 31, and the current sensor 32 are connected to the electric brake ECU 29.

The electric brake ECU 29 (and the first ECU 10 and the second ECU 11 connected to this electric brake ECU 29 via the CAN 12) can acquire the rotational angle of the electric motor 23 based on the signal from the rotational angle sensor 30. The electric brake ECU 29 (and the first ECU 10 and the second ECU 20) can acquire the thrust force working on the piston 26 based on the signal from the thrust force sensor 31. The electric brake ECU 29 (and the first ECU 10 and the second ECU 11) can acquire the motor current supplied to the electric motor 23 based on the signal from the current sensor 32.

Next, the operations of applying the braking and releasing the braking by the electric brake mechanisms 5 and 6 will be described. In the following description, these operations will be described citing the operations when the driver operates the brake pedal 7 as an example. However, the electric brake mechanisms 5 and 6 also operate approximately similarly even in the case of autonomous brake, except that the operations in this case are different in terms of, for example, the fact that an instruction for the autonomous brake is output from an autonomous brake ECU (not illustrated), the first ECU 10, or the second ECU 11 to the electric brake ECU 29.

For example, when the driver operates the brake pedal 7 by pressing it while the vehicle 1 is running, the first ECU 10 and the second ECU 11 each output an instruction according to the pressing operation on the brake pedal 7 (a control instruction according to a target thrust force instruction value) to the electric brake ECU 29 based on the detection signal input from the pedal stroke sensor 9. The electric brake ECU 29 drives (rotates) the electric motor 23 in a forward direction, i.e., in a braking application direction (an applying direction) based on the instruction from the first ECU 10 and the second ECU 11. The rotation of the electric motor 23 is transmitted to the rotation-linear motion conversion mechanism 25 via the speed reduction mechanism 24, and the piston 26 is moved forward toward the brake pads 27.

As a result, the brake pads 27 are pressed against the disk rotor D, and the braking force is applied. At this time, the braking state is established due to the control on the driving of the electric motor 23 based on the detection signals from the pedal stroke sensor 9, the rotational angle sensor 30, the thrust force sensor 31, and the like. While such control is ongoing, the force in the braking release direction is applied to the rotational member of the rotation-linear motion conversion mechanism 25 and thus the rotational shaft of the electric motor 23 by the not-illustrated return spring provided to the brake mechanism 21.

On the other hand, when the brake pedal 7 is operated toward a pressing release side, the first ECU 10 and the second ECU 11 each output an instruction according to this operation (the control instruction according to the target thrust force instruction value) to the electric brake ECU 29. The electric brake ECU 29 drives (rotates) the electric motor 23 in a reverse direction, i.e., in a braking release direction (a releasing direction) based on the instruction from the first ECU 10 and the second ECU 11. The rotation of the electric motor 23 is transmitted to the rotation-linear motion conversion mechanism 25 via the speed reduction mechanism 24, and the piston 26 is moved backward in a direction away from the brake pads 27. Then, when the pressing of the brake pedal 7 is completely released, the brake pads 27 are separated from the disk rotor D, thereby releasing the braking force. In a non-braking state in which the braking is released in this manner, the not-illustrated return spring provided to the brake mechanism 21 is returned to the initial state thereof.

Next, the thrust force control and the position control by the electric brake mechanisms 5 and 6 will be described.

The first ECU 10 and the second ECU 11 determine a braking force that should be generated by each of the electric brake mechanisms 5 and 6, i.e., a target thrust force that should be generated on the piston 26 based on the detection data from the various kinds of sensors (for example, the pedal stroke sensor 9), the autonomous brake instruction, and the like. The first ECU 10 and the second ECU 11 each output the braking instruction (the control instruction) according to the target thrust force to the electric brake ECU 29. The electric brake ECU 29 controls the thrust force based on the piston thrust force detected by the thrust force sensor 31 as a feedback and controls the position based on the motor rotational position detected by the rotational angle sensor 30 as a feedback on the electric motor 23 so as to generate the target thrust force on the piston 26.

In other words, in the brake mechanism 21, the thrust force of the piston 26 is adjusted based on the braking instruction (the target thrust force) from the first ECU 10 and the second ECU 11 and the feedback signal from the thrust force sensor 31, which measures the thrust force of the piston 26. To determine the thrust force, the brake mechanism 21 performs torque control of the electric motor 23 via the rotation-linear motion conversion mechanism 25 and the speed reduction mechanism 24, i.e., current control based on a feedback signal of the current sensor 32, which measures a current amount supplied to the electric motor 23. Therefore, the braking force, and the piston thrust force, the torque of the electric motor 23 (the motor torque), the current value, and the piston position (a value indicating the number of rotations of the electric motor 23 that is measured by the rotational angle sensor 30) are in a correlated relationship. However, the control based on the thrust force sensor 31, which detects (measures) the piston thrust force (a piston pressing force) strongly correlated with the braking force, is desirable because the braking force varies depending on the environment and a variation in the components.

The thrust force sensor 31 can be formed by, for example, a strain sensor that deforms a metallic strain generation element in reaction to the force of the piston 26 in the thrust direction and detects the strain amount thereof. The strain sensor is a strain IC, and includes a piezoresistance that detects a strain at the center of the top surface of a silicon chip, and a Wheatstone bridge, an amplification circuit, and a semiconductor process disposed around it. The strain sensor detects the strain applied to the strain sensor as a resistance change by utilizing the piezoresistance effect. The strain sensor may be formed by a strain gauge or the like.

Now, the above-described patent literature, PTL 1 discusses the electric brake apparatus that includes the first piston and the second piston controllable independently of each other. Using such an electric brake apparatus to control a vehicle behavior necessitates fine control of the braking force, i.e., accuracy of controlling the thrust force of the piston (the piston thrust force). In light thereof, the first embodiment is configured to be able to improve the accuracy of controlling the piston thrust forces of the first left front electric brake mechanism 5L1 and the second left front electric brake mechanism 5L2 controllable independently of each other. Further, the first embodiment is configured to be able to improve the accuracy of controlling the piston thrust forces of the first right front electric brake mechanism 5R1 and the second right front electric brake mechanism 5R2 controllable independently of each other. Now, the details thereof will be described.

In the embodiment, the vehicle 1 includes the left front electric brake mechanisms 5L1 and 5L2. Further, the vehicle 1 includes the right front electric brake mechanisms 5R1 and 5R2. The left front electric brake mechanisms 5L1 and 5L2 form a vehicle control system together with the first ECU 10. The right front electric brake mechanisms 5R1 and 5R2 form the vehicle control system together with the second ECU 11. More specifically, a control portion 10A of the first ECU 10 outputs the calculation result (for example, the control instruction according to the target thrust force) to the electric brake ECUs 29 and 29 of the “left front electric brake mechanisms 5L1 and 5L2” and the electric brake ECU 29 of the “right rear electric brake mechanism 6R”. On the other hand, a control portion 11A of the second ECU 11 outputs the calculation result (for example, the control instruction according to the target thrust force) to the electric brake ECUs 29 and 29 of the “right front electric brake mechanisms 5R1 and 5R2” and the electric brake ECU 29 of the “left rear electric brake mechanism 6L”.

In this manner, in the embodiment, the left front electric brake mechanisms 5L1 and 5L2 and the right rear electric brake mechanism 6R are controlled by the control portion 10A of the first ECU 10, and the right front electric brake mechanisms 5R1 and 5R2 and the left rear electric brake mechanism 6L are controlled by the control portion 11A of the second ECU 11. In the following description, the present embodiment will be described mainly focusing on the control of the left front electric brake mechanisms 5L1 and 5L2 by the first ECU 10. The control of the right front electric brake mechanisms 5R1 and 5R2 by the second ECU 11 is similar to the control of the left front electric brake mechanisms 5L1 and 5L2 by the first ECU 10 except for the difference that they are the left side and the right side, and therefore the detailed description thereof will be omitted here.

The left front electric brake mechanisms 5L1 and 5L2 apply the braking force to the left front wheel 3L, which is a wheel of the vehicle 1, by thrusting a thrust portion including a first thrust portion and a second thrust portion controllable independently of each other. The first thrust portion corresponds to, for example, the electric motor 23 and the piston 26 of the first left front electric brake mechanism 5L 1. The second thrust portion corresponds to, for example, the electric motor 23 and the piston 26 of the second left front electric brake mechanism 5L2. In other words, the first left front electric brake mechanism 5L1 includes the electric motor 23 (hereinafter referred to as the first electric motor 23), and the piston 26 (hereinafter referred to as the first piston 26) that is thrust by actuating this first electric motor 23. The second left front electric brake mechanism 5L2 includes the electric motor 23 (hereinafter referred to as the second electric motor 23), and the piston 26 (hereinafter referred to as the second piston 26) that is thrust by actuating this second electric motor 23.

As illustrated in FIG. 2, the left front electric brake mechanisms 5L1 and 5L2 include the common caliper 22A shared by the first left front electric brake mechanism 5L1 and the second left front electric brake mechanism 5L2. The caliper 22A presses a pair of brake pads 27 against the disk rotor D according to the thrust movement of the first piston 26 and the second piston 26 in the caliper 22A. In this case, the second piston 26 is disposed on a rotationally entering side, which is an entrance side of the caliper 22A with respect to the rotational direction of the disk rotor D. In other words, the first piston 26 is disposed on a rotationally exiting side, which is an exit side of the caliper 22A with respect to the rotational direction of the disk rotor D. In FIGS. 1 and 2, the members on the rotationally exiting side are defined to be “first” and the members on the rotationally entering side are defined to be “second” based on the rotational direction of the disk rotor D (the counterclockwise direction) when the vehicle 1 moves forward. However, when the vehicle 1 moves rearward, the rotational direction of the disk rotor D is reversed (into the clockwise direction). In this case, i.e., when the vehicle 1 moves rearward, the members defined to be “first” in FIGS. 1 and 2 are switched to “second” and the members defined to be “second in FIGS. 1 and 2 are switched to “first”. For example, the wheel speed sensor 13 detects the traveling direction of the vehicle 1, i.e., the rotational direction of the disk rotor D, if the wheel speed sensor 13 is capable of it. Alternatively, the acceleration sensor mounted on the vehicle 1 may detect the rotational direction of the disk rotor D.

The first ECU 10 (more specifically, the control portion 10A) performs the following vehicle control. That is, the first ECU 10 (the control portion 10A) acquires the target thrust force instruction value to be generated on the thrust portion based on the target braking force to be applied to the left front wheel 3L. Now, the target braking force corresponds to the target value of the braking force that should be applied to the left front wheel 3L according to the stroke amount (the pedal displacement amount) of the pedal stroke sensor 9. Alternatively, in the case where the pressing force sensor is provided, the target braking force corresponds to the target value of the braking force that should be applied to the left front wheel 3L according to the pedal pressing force of the pressing force sensor. Further alternatively, the target braking force corresponds to the target value of the braking force that should be applied to the left front wheel 3L according to an autonomous brake instruction (a deceleration instruction) issued by the autonomous brake. The first ECU 10 (the control portion 10A) acquires the stroke signal output by the pedal stroke sensor 9, the pressing force signal according to the pedal pressing force, or the deceleration instruction signal issued by the autonomous brake. As a result, the first ECU 10 (the control portion 10A) acquires the target thrust force instruction value serving as the instruction value of the target thrust force to be generated on the thrust portion (i.e., the first piston 26 of the first thrust portion and the second piston 26 of the second thrust portion) for applying the target braking force. The target thrust force instruction value may be the value of the target thrust force itself, may be a signal corresponding to the value of the target thrust force, or may be a current value for acquiring the target thrust force.

The first ECU 10 (the control portion 10A) outputs a “first control instruction” for actuating the first electric motor 23 of the first thrust portion and a “second control instruction” for actuating the second electric motor 23 of the second thrust portion to the electric brake ECUs 29 and 29 according to a physical amount regarding a change in the target thrust force instruction value. The “physical amount regarding a change in the target thrust force instruction value” can be a change amount of the target thrust force instruction value, such as a difference between the target thrust force instruction value in the previous control period and the target thrust force instruction value in the present control period. In other words, the first ECU 10 (the control portion 10A) outputs the first control instruction to the electric brake ECU 29 of the first left front electric brake mechanism 5L1 and outputs the second control instruction to the electric brake ECU 29 of the second left front electric brake mechanism 5L2 according to the difference between the target thrust force instruction value in the previous control period and the target thrust force instruction value in the present control period (the difference in the target thrust force instruction value). For example, a change rate (a change speed) of the target thrust force instruction value may be used as the “physical amount regarding a change in the target thrust force instruction value”, besides the change amount of the target thrust force instruction value.

Such control performed by the first ECU 10 (the control portion 10A), i.e., processing for outputting the first control instruction and the second control instruction according to the change amount of the target thrust force instruction value (the difference between the target thrust force instruction value in the previous control period and the target thrust force instruction value in the present control period) will be described with reference to a flow diagram (a flowchart) of FIG. 4. FIG. 4 is a flowchart illustrating processing for outputting the control instructions (the first control instruction and the second control instruction) for thrusting the first piston 26 on the rotationally exiting side and the second piston 26 on the rotationally entering side according to the change amount of the target piston thrust force, which is the target thrust force instruction value. The control processing in FIG. 4 is repeatedly performed per predetermined control period (for example, per 10 ms), after the first ECU 10 (the control portion 10A) is started up.

In FIG. 4, “Fnow” represents a total target thrust force instruction value Fnow of the first piston 26 and the second piston 26 in the present control period (also referred to as a piston thrust force instruction value Fnow). “Fbef” represents a total target thrust force instruction value Fbef of the first piston 26 and the second piston 26 in the previous control period (also referred to as a piston thrust force instruction value Fbef). “ΔF” represents a difference between Fnow and Fbef, i.e., a change amount ΔF of the target thrust force instruction value between the present control period and the previous control period (also referred to as a change amount ΔF of the piston thrust force instruction value). “ΔFthr1 ” represents a first threshold value ΔFthr1, and a determination value (a piston thrust force threshold value) for determining whether to “thrust both the first piston 26 and the second piston 26 (actuate both the first electric motor 23 and the second electric motor 23)” or “thrust one of the first piston 26 and the second piston 26 (actuate one of the first electric motor 23 and the second electric motor 23)”. “F1” represents a previous first control instruction, i.e., a previous target thrust force instruction value F1 of the first piston 26 (also referred to as a piston thrust force instruction value F1). “F2” represents a previous second control instruction, i.e., a previous target thrust force instruction value F2 of the second piston 26 (also referred to as a piston thrust force instruction value F2).

“F1temp” represents a temporary first control instruction in the present control period, i.e., a temporary target thrust force instruction calculated value F1temp of the first piston 26 in the present control period (also referred to as a piston thrust force instruction calculated value F1temp). “F2temp” represents a temporary second control instruction in the present control period, i.e., a temporary target thrust force instruction calculated value F2temp of the second piston 26 in the present control period (also referred to as a piston thrust force instruction calculated value F2temp). “ΔFthr2” represents a second threshold value ΔFthr2, and a determination value (a piston thrust force threshold value) for determining whether to “actuate the first piston 26 (the first electric motor 23)” or “actuate the second piston 26 (the second electric motor 23)”. “F1max” represents a third threshold value F1max, and a maximum value of the first control instruction, i.e., an upper limit target thrust force instruction value F1max of the first piston 26 (also referred to as an upper limit piston thrust force instruction value F1max).

When the control processing in FIG. 4 is started due to a power-on of the system (a start of power supply to the first ECU 10), in S1, the first ECU 10 acquires the total piston thrust force instruction value Fnow of the first piston 26 and the second piston 26 in the present control period. In S2 subsequent thereto, the first ECU 10 calculates the change amount ΔF of the piston thrust force instruction value, which is the difference (an absolute value) between the “total piston thrust force instruction value Fbef of the first piston 26 and the second piston 26 in the previous control period” and the “total piston thrust force instruction value Fnow of the first piston 26 and the second piston 26 in the present control period”. The first ECU 10 calculates the change amount ΔF of the piston thrust force instruction value as the physical amount regarding the change in the instruction value in S2, but may calculate, for example, the change rate or the change speed of the piston thrust force instruction value or the change amount of the current (the total current) supplied to the first electric motor 23 and the second electric motor 23.

In S3 subsequent to S2, the first ECU 10 determines whether to thrust both the first piston 26 and the second piston 26 (actuate both the first electric motor 23 and the second electric motor 23) or thrust (actuate) one of them. The first ECU 10 makes this determination based on the magnitude of the change amount ΔF (the absolute value) of the piston thrust force instruction value. More specifically, if the change amount ΔF of the piston thrust force instruction value is equal to or smaller than the preset first threshold value ΔFthr1, the first ECU 10 thrusts one of the first piston 26 and the second piston 26 (actuates one of the electric motors 23). On the other hand, if the change amount ΔF of the piston thrust force instruction value exceeds the first threshold value ΔFthr1, the first ECU 10 thrusts both the first piston 26 and the second piston 26 (actuates both the electric motors 23 and 23). The first threshold value ΔFthr1 can be set based on a design value of, for example, the change amount of the piston thrust force instruction value that can be generated by one of the pistons 26. In other words, the first threshold value ΔFthr1 can be set according to, for example, the specifications and the performance of the vehicle as a threshold value for the thrust force (the braking force) that can be applied by one of the pistons 26.

If the determination in S3 is “NO”, i.e., the first ECU 10 determines that the change amount ΔF of the piston thrust force instruction value exceeds the first threshold value ΔFthr1, the first ECU 10 proceeds to S4. In this case, the first ECU 10 thrusts both the first piston 26 and the second piston 26 (actuates both the first electric motor 23 and the second electric motor 23). Now, the instruction for thrusting the first piston 26 (the instruction for actuating the first electric motor 23) will be referred to as the “first control instruction”, and the instruction for thrusting the second piston 26 (the instruction for actuating the second electric motor 23) will be referred to as the “second control instruction”. In S4, the first ECU 10 sets the instruction directed to the first piston 26 (a “piston 1”) to a value resulting from adding a half (ΔF/2) of the change amount ΔF of the piston thrust force instruction value to the piston thrust force instruction value F1 in the previous control period and sets the instruction directed to the second piston 26 (a “piston 2”) to a value resulting from adding a half (ΔF/2) of the change amount ΔF of the piston thrust force instruction value to the piston thrust force instruction value F2 in the previous control period to thrust both the first piston 26 and the second piston 26.

In other words, in S4, the first ECU 10 calculates the first control instruction in the present control period as a sum of the “previous piston thrust force instruction value F1 of the first piston 26” and a “½ of the change amount ΔF of the piston thrust force instruction value”, and calculates the second control instruction in the present control period as a sum of the “previous piston thrust force instruction value F2 of the second piston 26” and a “½ of the change amount ΔF of the piston thrust force instruction value”. The first ECU 10 (the control portion 10A) outputs the calculated present first control instruction to the electric brake ECU 29 of the first left front electric brake mechanism 5L 1 as the instruction directed to the first electric motor 23, and outputs the calculated present second control instruction to the electric brake ECU 29 of the second left front electric brake mechanism 5L2 as the instruction directed to the second electric motor 23. After outputting the first control instruction and the second control instruction in the present control period in S4, the first ECU 10 returns. In other words, the first ECU 10 returns to START via END, and repeats the processing in step S1 and the subsequent steps.

On the other hand, if the determination in S3 is “YES”, i.e., the first ECU 10 determines that the change amount ΔF of the piston thrust force instruction value is equal to or smaller than the first threshold value ΔFthr1, the first ECU 10 proceeds to S5. In this case, the first ECU 10 thrusts any one of the first piston 26 and the second piston 26 (actuates the first electric motor 23 or the second electric motor 23). In S5, the first ECU 10 calculates the piston thrust force instruction calculated value F1temp of the first piston 26 and the piston thrust force instruction calculated value F2temp of the second piston 26, hypothetically assuming that the first piston 26 is thrust. The first ECU 10 calculates F1temp as a sum of the “previous piston thrust force instruction value F1 of the first piston 26” and the “change amount ΔF of the piston thrust force instruction value”. The first ECU 10 calculates F2temp as the “previous piston thrust force instruction value F2 of the second piston 26”.

In S6 subsequent to S5, the first ECU 10 determines whether the first piston 26 can be thrust. The first ECU 10 makes this determination based on the magnitude of the “difference between F1temp and F2temp (the absolute value)” and the magnitude of “F1tem”. More specifically, in S6, the first ECU 10 determines whether the difference between F1temp and F2temp is equal to or smaller than the preset second threshold value ΔFthr2 and F1temp is also equal to or smaller than the preset third threshold value F1max. A reason for determining the magnitude of the difference between F1temp and F2temp is that an excessive increase in the difference in the piston thrust force between the first piston 26 and the second piston 26 might lead to a difference in the wear amount of the brake pad 27, thereby resulting in uneven wear of the brake pad 27. Another reason is that a difference in the actuation frequency between the first piston 26 and the second piston 26 might lead to an increase in the load on one of the pistons 26, thereby resulting in the fast advancement of the deterioration of only one of the pistons 26. Further, the first ECU 10 determines the magnitude of F1temp for the purpose of determining whether F1temp is a piston thrust force instruction value in a thrustable range of the first piston 26. The second threshold value ΔFthr2 can be set based on a design value of, for example, the difference in the piston thrust force that makes the actuation frequency more even between the first piston 26 and the second piston 26. Further, the third threshold value F1max can be set based on a design value of, for example, the piston thrust force maximum value that can be generated by one of the pistons 26.

If the determination in S6 is “YES”, i.e., the first ECU 10 determines that the difference between F1temp and F2temp is equal to or smaller than the second threshold value ΔFthr2, and F1temp is also equal to or smaller than the third threshold value F1max (the upper limit piston thrust force instruction value F1max), the first ECU 10 proceeds to S7. In this case, the first ECU 10 thrusts only the first piston 26 (actuates only the first electric motor 23). In other words, in S7, the first ECU 10 sets the instruction directed to the first piston 26 (the “piston 1”) to a value resulting from adding the change amount ΔF of the piston thrust force instruction value to the piston thrust force instruction value F1 in the previous control period, and sets the instruction directed to the second piston 26 (the “piston 2”) to the piston thrust force instruction value F2 in the previous control period. More specifically, in S7, the first ECU 10 calculates the first control instruction in the present control period as a sum of the “previous piston thrust force instruction value F1 of the first piston 26” and the “change amount ΔF of the piston thrust force instruction value”, and calculates the second control instruction in the present control period as the “previous piston thrust force instruction value F2 of the second piston 26”. The first ECU 10 (the control portion 10A) outputs the calculated present first control instruction (F1+ΔF) to the electric brake ECU 29 of the first left front electric brake mechanism 5L1 as the instruction directed to the first electric motor 23, and outputs the calculated present second control instruction (F2) to the electric brake ECU 29 of the second left front electric brake mechanism 5L2 as the instruction directed to the second electric motor 23. As a result, only the first electric motor 23 is actuated. The second electric motor 23 is not actuated (the present thrust force is maintained). In other words, the second control instruction works as an instruction for not actuating the second electric motor 23 (an instruction for maintaining the current thrust force). After outputting the first control instruction and the second control instruction in the present control period in S7, the first ECU 10 returns (ends the processing).

On the other hand, if the determination in S6 is “NO”, i.e., the first ECU 10 determines that the difference between F1 temp and F2temp is larger than the second threshold value ΔFthr2 or F1temp is larger than the third threshold value F1max (the upper limit piston thrust force instruction value F1max), the first ECU 10 proceeds to S8. In this case, the first ECU 10 thrusts only the second piston 26 (actuates only the second electric motor 23). In other words, in S8, the first ECU 10 sets the instruction directed to the first piston 26 (the “piston 1”) to the piston thrust force instruction value F1 in the previous control period, and sets the instruction directed to the second piston 26 (the “piston 2”) to a value resulting from adding the change amount ΔF of the piston thrust force instruction value to the piston thrust force instruction value F2 in the previous control period. More specifically, in S8, the first ECU 10 calculates the first control instruction in the present control period as the “previous piston thrust force instruction value F1 of the first piston 26”, and calculates the second control instruction in the present control period as a sum of the “previous piston thrust force instruction value F2 of the second piston 26” and the “change amount ΔF of the piston thrust force instruction value”. The first ECU 10 (the control portion 10A) outputs the calculated present first control instruction (F1) to the electric brake ECU 29 of the first left front electric brake mechanism 5L1 as the instruction directed to the first electric motor 23, and outputs the calculated present second control instruction (F2+ΔF) to the electric brake ECU 29 of the second left front electric brake mechanism 5L2 as the instruction directed to the second electric motor 23. As a result, the first electric motor 23 is not actuated (the present thrust force is maintained). Only the second electric motor 23 is actuated. In other words, the first control instruction works as an instruction for not actuating the first electric motor 23 (an instruction for maintaining the current thrust force). After outputting the first control instruction and the second control instruction in the present control period in S8, the first ECU 10 returns (ends the processing).

In this manner, in the first embodiment, the first ECU 10 (the control portion 10A) determines “YES” in S3 in FIG. 4, if the change amount ΔF of the piston thrust force instruction value, which is the change amount of the target thrust force instruction value, is equal to or smaller than the predetermined first threshold value ΔFthr1. In this case, the first ECU 10 (the control portion 10A) outputs the first control instruction and the second control instruction so as to actuate the first electric motor 23, which is the first thrust portion, and also restrict the actuation of the second electric motor 23, which is the second thrust portion. More specifically, the first ECU 10 (the control portion 10A) proceeds to S7 in FIG. 4, and outputs the first control instruction (F1+ΔF) and the second control instruction (F2) so as to actuate only the first electric motor 23, which is the first thrust portion. In other words, when proceeding to S7 in FIG. 4, the first ECU 10 (the control portion 10A) outputs the first control instruction (F1+ΔF) and the second control instruction (F2) so as to actuate the first electric motor 23 of the first piston 26 located on the rotationally exiting side and also restrict the actuation of the second piston 26 located on the rotationally entering side (more specifically, so as to actuate only the first electric motor 23 of the first piston 26 located on the rotationally exiting side).

In this case, the first ECU 10 (the control portion 10A) proceeds from S6 to S7 in FIG. 4. More specifically, the first ECU 10 (the control portion 10A) proceeds to S7, if the difference between the “first target thrust force instruction value (F1temp), which is the instruction value of the first thrust portion (the first electric motor 23) in the target thrust force instruction value Fnow”, and the “second target thrust force instruction value (F2temp), which is the instruction value of the second thrust portion (the second electric motor 23) in the target thrust force instruction value Fnow”, (|F1temp−F2temp|) is equal to or smaller than the predetermined second threshold value ΔFthr2. In S7, the first ECU 10 outputs the first control instruction (F1+ΔF) and the second control instruction (F2) so as to actuate the first thrust portion (the first electric motor 23) and also restrict the actuation of the second thrust portion (the second electric motor 23) (more specifically, actuate only the first electric motor 23). Further, the first ECU 10 (the control portion 10A) also proceeds from S3 to S8 via S5 and S6 in FIG. 4, if the change amount ΔF of the piston thrust force instruction value, which is the change amount of the target thrust force instruction value, is equal to or smaller than the predetermined first threshold value ΔFthr1. More specifically, the first ECU 10 (the control portion 10A) outputs the first control instruction (F1) and the second control instruction (F2+ΔF) so as to actuate only the second thrust portion (the second electric motor 23), if the change amount ΔF of the piston thrust force instruction value is equal to or smaller than the first threshold value ΔFthr1, and the difference between the first target thrust force instruction value (F1temp) and the second target thrust force instruction value (F2temp) (|F1temp−F2temp|) is also larger than the predetermined second threshold value Δthr2.

The generated piston thrust force value may be detected by the thrust force sensor 31, or may be acquired by being detected by the wheel speed sensor 13 or the acceleration sensor and calculated therefrom. Further, FIG. 4 illustrates the flowchart in which the actuation of the first piston 26 is prioritized, but may be modified into such a flowchart that the actuation of the second piston 26 is prioritized. In other words, in FIG. 4, priority is placed on the actuation of the first piston, which is the piston on the rotationally exiting side. A reason therefor is that the actuation of the piston on the rotationally exiting side is more effective to reduce the occurrence of noise and a vibration compared to when the piston on the rotationally entering side is actuated. However, the piston on the rotationally entering side and the piston on the rotationally exiting side may be switched to the first piston and the second piston, respectively. Alternatively, for example, priority may be placed on a different piston when an arbitrary time has elapsed. Alternatively, for example, the first piston 26 and the second piston 26 may be actuated in such a manner that the actuation thereof is alternately prioritized. Alternatively, the present embodiment may be configured in such a manner that the first piston 26 on the rotationally exiting side is actuated when only one of the pistons 26 is actuated (the force is increased) from the thrust force 0. A purpose thereof is to reduce the occurrence of noise and a vibration when the vehicle starts running, at which surrounding noise is highly audible.

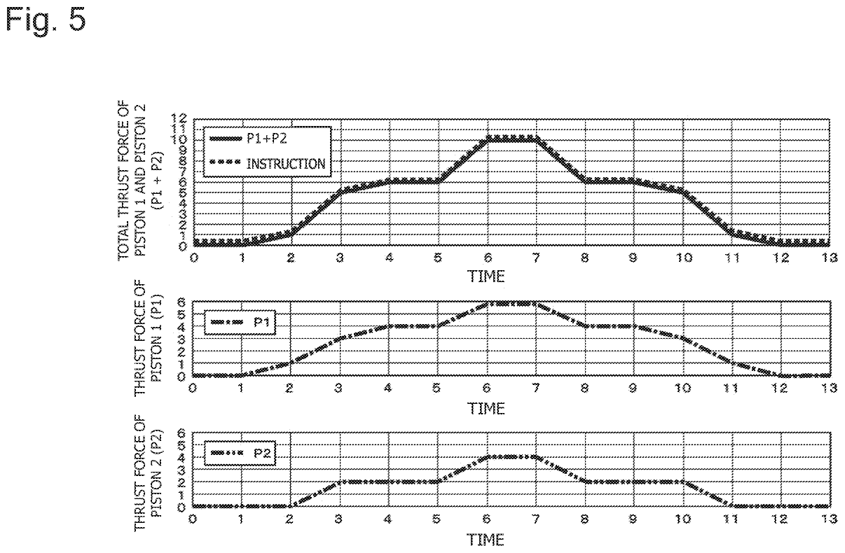

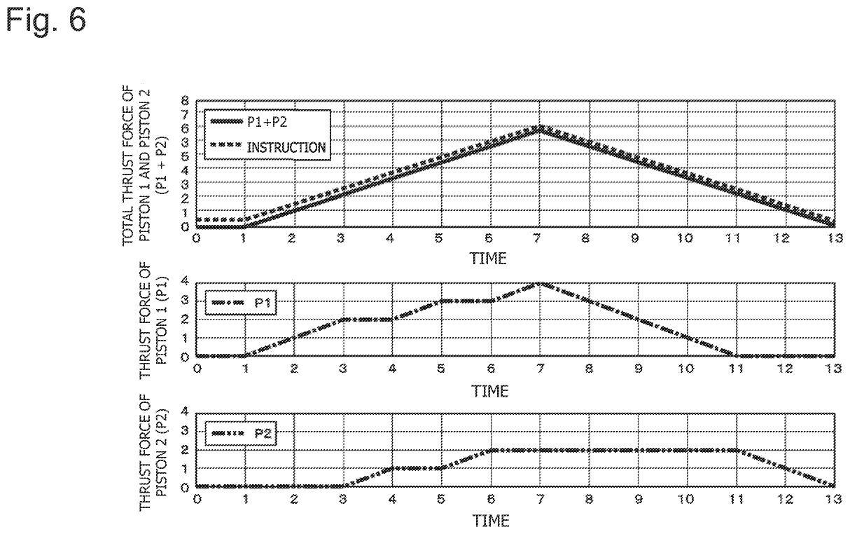

FIG. 5 is a timing chart illustrating the operations of the first piston 26 (the “piston 1”) and the second piston 26 (the “piston 2”) when the first ECU 10 acquires the piston thrust force instruction value with which only “YES” is determined in S6 in the flowchart illustrated in FIG. 4. FIG. 5 illustrates the timing chart in the case where the first piston 26 is actuated when one of the pistons is actuated. In FIG. 5, the first threshold value ΔFthr1 is assumed to be “1” and the second threshold value ΔFthr2 is assumed to be “3”. On the other hand, FIG. 6 is a timing chart illustrating the operations of the first piston 26 (the “piston 1”) and the second piston 26 (the “piston 2”) when the first ECU 10 acquires the piston thrust force instruction value that also includes a possibility of the determination of “NO” in S6 in the flowchart illustrated in FIG. 4. In FIG. 6, the first piston 26 is actuated in some cases and the second piston 26 is actuated in other cases when one of the pistons is actuated. In FIG. 5, the first threshold value ΔFthr1 is also assumed to be “1” and the second threshold value ΔFthr2 is also assumed to be “3”. As clearly understood from such FIGS. 5 and 6, the first embodiment can achieve fine adjustments (fine control) of the thrust forces exerted by the first thrust portion (the first electric motor 23 and the first piston 26) and the second thrust portion (the second electric motor 23 and the second piston 26).

In this manner, according to the first embodiment, the first ECU 10 (the control portion 10A) outputs the first control instruction, which is the piston thrust force instruction value of the first piston 26, and the second control instruction, which is the piston thrust force instruction value of the second piston 26, according to the physical amount regarding the change in the piston thrust force instruction value, i.e., the change amount ΔF of the piston thrust force instruction value. Therefore, the first electric motor 23 (the first piston 26), which is the first thrust portion, and the second electric motor 23 (the second piston 26), which is the second thrust portion, can be actuated according to the change amount ΔF of the piston thrust force instruction value at that time. In this case, the first ECU 10 (the control portion 10A) can actuate both the first electric motor 23 (the first piston 26) and the second electric motor 23 (the second piston 26) according to, for example, the change amount ΔF of the piston thrust force instruction value at the present moment. Alternatively, the first ECU 10 (the control portion 10A) can, for example, actuate the first electric motor 23 (the first piston 26) and also restrict the actuation of the second electric motor 23 (the second piston 26) (for example, prohibits the actuation thereof) according to the change amount ΔF of the piston thrust force instruction value at the present moment. Alternatively, the first ECU 10 (the control portion 10A) can, for example, actuate the second electric motor 23 (the second piston 26) and also restrict the actuation of the first electric motor 23 (the first piston 26) (for example, prohibits the actuation thereof) according to the change amount ΔF of the piston thrust force instruction value at the present moment. As a result, the first embodiment can achieve fine adjustments (fine control) of the thrust forces (the piston thrust forces) of the first piston 26 and the second piston 26 generated by the first electric motor 23 and the second electric motor 23, thereby improving the accuracy of controlling the thrust forces of the first piston 26 and the second piston 26.

According to the first embodiment, the first ECU 10 (the control portion 10A) actuates the first electric motor 23 (the first piston 26) and also restricts the actuation of the second electric motor 23 (the second piston 26), if the change amount ΔF of the piston thrust force instruction value is small (equal to or smaller than the first threshold value ΔFthr1). In this case, the first ECU 10 (the control portion 10A) actuates the first electric motor 23 (the first piston 26) and also restricts the actuation of the second electric motor 23 (the second piston 26), if the difference between the piston thrust force instruction calculated value F1temp, which is the instruction value of the first electric motor 23 (the first piston 26), and the piston thrust force instruction calculated value F2temp, which is the instruction value of the second electric motor 23 (the second piston 26). (|F1temp−F2temp|) is small (if this difference is equal to or smaller than the second threshold value ΔFthr2). More specifically, the first ECU 10 (the control portion 10A) actuates only the first electric motor 23 (the first piston 26) and does not actuate the second electric motor 23 (the second piston 26) to maintain the present thrust force, if the change amount ΔF of the piston thrust force instruction value is small and the difference between the target thrust force instruction calculated value F1temp of the first piston 26 and the target thrust force instruction calculated value F2temp of the second piston 26 is small. As a result, the first embodiment can achieve fine adjustments (fine control) of the thrust forces exerted by the first piston 26 and the second piston 26 by prioritizing the actuation of the first electric motor 23 over the actuation of the second electric motor 23 while suppressing an increase in the difference between the thrust force of the first piston 26 generated by the first electric motor 23 and the thrust force of the second piston 26 generated by the second electric motor 23.

According to the first embodiment, the first ECU 10 (the control portion 10A) actuates only the second electric motor 23 (the second piston 26) and does not actuate the first electric motor 23 (the first piston 26) to maintain the present thrust force, if the change amount ΔF of the piston thrust force instruction value is small and the difference between the target thrust force instruction calculated value F1temp of the first piston 26 and the target thrust force instruction calculated value F2temp of the second piston 26 is large (larger than the second threshold value ΔFthr2). As a result, the thrust force of the second piston 26 can be adjusted closer to the thrust force of the first piston 26, the actuation of which is prioritized. Therefore, the first embodiment can suppress an increase in the difference between the thrust force of the first piston 26 generated by the first electric motor 23 and the thrust force of the second piston 26 generated by the second electric motor 23 even when the actuation of the first electric motor 23 is prioritized so as to achieve fine adjustments (fine control) of the thrust forces (the piston thrust forces) generated by the first electric motor 23 and the second electric motor 23.

According to the first embodiment, the first ECU 10 (the control portion 10A) can prioritize the thrust of the first piston 26 on the rotationally exiting side, which is the exit side of the caliper 22A. In this case, the present embodiment can more effectively reduce the occurrence of noise and a vibration accompanying braking by prioritizing the thrust of the first piston 26 on the rotationally exiting side than when the thrust of the second piston 26 on the rotationally entering side is prioritized.

Next, FIGS. 7 and 8 illustrate a second embodiment. The second embodiment is characterized in that the electric brake mechanism on the front wheel side is formed by two electric motors and one piston, and the change amount of the current is used as the physical amount regarding the change in the target thrust force instruction value. The second embodiment will be described, identifying similar components to the above-described first embodiment by the same reference numerals and omitting descriptions thereof.

The left front electric brake mechanism 5L, which is the electric brake mechanism on the left front side, includes a brake mechanism 41, two electric motors (not illustrated), and the two electric brake ECUs 29 and 29. Similarly, the right front electric brake mechanism 5R, which is the electric brake mechanism on the right front side, also includes the brake mechanism 41, two electric motors (not illustrated), and the two electric brake ECUs 29 and 29. The brake mechanism 41 includes, for example, a caliper 42 as the cylinder (the wheel cylinder), a single piston 43 as the pressing member, and brake pads (not illustrated) as the braking member (the pads). Further, one speed reduction mechanism and one rotation-linear motion conversion mechanism (both are unillustrated) are provided to the brake mechanism 41.

In other words, in the second embodiment, the electric brake mechanisms 5L and 5R on the front side are configured to thrust the single piston 43 by actuating both or one of the two electric motors. Then, the electric brake mechanisms 5L and 5R include the two electric brake ECUs 29 in correspondence with the respective electric motors, and the electric brake ECUs 29 control the respective electric motors independently of each other. The electric brake mechanisms 5L and 5R may be configured to include one electric brake ECU as long as the respective electric motors can be controlled independently of each other using one electric brake ECU. Now, in the second embodiment, the thrust force is adjusted using torque control of the electric motor via the rotation-linear motion conversion mechanism and the speed reduction mechanism, i.e., current control based on a feedback signal of the current sensor that measures the current amount supplied to the electric motor and the change amount of the current when the current is supplied. In this case, the change amount of the current is estimated using a piston thrust force change coefficient K with respect to the change amount of the current. In other words, in the second embodiment, the thrust force sensor 31, like the first embodiment, is omitted. The generated piston thrust force value may be acquired by being detected by the wheel speed sensor 13 or the acceleration sensor and calculated therefrom.

In the second embodiment, the electric brake mechanisms 5L and 5R on the front side apply the braking force to the front wheels 3L and 3R, which are the wheels of the vehicle 1, by each thrusting the thrust portion including the first thrust portion and the second thrust portion controllable independently of each other. The first thrust portion corresponds to, for example, one of the two electric motors (for example, the electric motor on the rotationally exiting side) and the piston 43. The second thrust portion corresponds to, for example, the other of the two electric motors (for example, the electric motor on the rotationally entering side) and the piston 43. In other words, the electric brake mechanisms 5L and 5R each include the first electric motor, which serves as the one of the two electric motors, the second electric motor, which serves as the other of the two electric motors, and the piston 43 that is thrust by actuating at least one of the first electric motor and the second electric motor.

Next, the control performed by the first ECU 10 (the control portion 10A), i.e., the processing for outputting the first control instruction and the second control instruction according to the change amount of the target thrust force instruction value (the difference between the target thrust force instruction value in the previous control period and the target thrust force instruction value in the present control period) will be described with reference to a flow diagram (a flowchart) of FIG. 8. In the flowchart illustrated in FIG. 8, a piston thrust force current instruction value is used instead of the piston thrust force instruction value used in the flowchart according to the above-described first embodiment (FIG. 4). Similar processing to the processing illustrated in FIG. 4 according to the above-described first embodiment, among processing procedures illustrated in FIG. 8, will be identified by the same step number, and the description thereof will be omitted here.

Further, in FIG. 8, “Fnow” represents the target thrust force instruction value Fnow of the piston 43 in the present control period (also referred to as the piston thrust force instruction value Fnow). “Fbef” represents the target thrust force instruction value Fbef of the piston 43 in the previous control period (also referred to as the piston thrust force instruction value Fbef). “ΔF” represents the difference between Fnow and Fbef, i.e., the change amount ΔF of the target thrust force instruction value between the present control period and the previous control period (also referred to as the change amount ΔF of the piston thrust force instruction value). “K” represents the piston thrust force change coefficient K with respect to ΔF. “ΔI” represents a current change amount corresponding to the change amount ΔF of the target thrust force instruction value (also referred to as a change amount ΔI of the piston thrust force current instruction value). “ΔIthr1” represents a first threshold value ΔIthr1, and a determination value (a piston thrust force current threshold value) for determining whether to “actuate both the first electric motor and the second electric motor” or “actuate one of the first electric motor and the second electric motor”. “I1” represents a previous first control instruction, i.e., a previous target thrust force instruction value I1 of the first electric motor (also referred to as a piston thrust force current instruction value I1). “I2” represents a previous second control instruction, i.e., a previous target thrust force instruction value I2 of the second electric motor (also referred to as a piston thrust force current instruction value I2).

“I1temp” represents a temporary first control instruction in the present control period, i.e., a temporary target thrust force instruction calculated value I1temp of the first electric motor in the present control period (also referred to as a piston thrust force current instruction calculated value I1temp). “I2temp” represents a temporary second control instruction in the present control period, i.e., a temporary target thrust force instruction calculated value I2temp of the second electric motor in the present control period (also referred to as a piston thrust force current instruction calculated value I2temp). “ΔIthr2” represents a second threshold value ΔIthr2, and a determination value (a piston thrust force current threshold value) for determining whether to “actuate the first electric motor” or “actuate the second electric motor”. “I1max” represents a third threshold value I1max, and a maximum value of the first control instruction, i.e., an upper limit target thrust force instruction value I1max of the first electric motor (also referred to as an upper limit piston thrust force current instruction value I1max).

In S11 subsequent to S2 in FIG. 8, the first ECU 10 calculates the change amount ΔI of the current instruction using the piston thrust force change coefficient K based on the change amount ΔF of the piston thrust force instruction value calculated in S2. In other words, the first ECU 10 calculates the “change amount ΔI of the piston thrust force current instruction value (=K×ΔF)” by multiplying the change amount ΔF of the piston thrust force instruction value by the piston thrust force change coefficient K.

In S12 subsequent S11, the first ECU 10 determines whether to actuate both the first electric motor and the second electric motor or actuate one of them based on the magnitude of the change amount ΔI (the absolute value) of the piston thrust force current instruction value. More specifically, if the change amount ΔI of the piston thrust force current instruction value is equal to or smaller than the preset first threshold value ΔIthr1, the first ECU 10 causes one of the first electric motor and the second electric motor to thrust the piston 43. On the other hand, if the change amount ΔI of the piston thrust force current instruction value exceeds the first threshold value ΔIthr1, the first ECU 10 causes both the first electric motor and the second electric motor to thrust the piston 43. The first threshold value ΔIthr1 can be set based on a design value of, for example, the change amount of the piston thrust force current instruction value that can be actuated by one of the electric motors.

In other words, the first threshold value ΔIthr1 can be set according to, for example, the specifications and the performance of the vehicle as a threshold value for the thrust force (the braking force) that can be applied by one of the electric motors.

If the determination in S12 is “NO”, i.e., the first ECU 10 determines that the change amount ΔI of the piston thrust force current value exceeds the first threshold value ΔIthr1, the first ECU 10 proceeds to S13. In this case, the first ECU 10 causes both the first electric motor and the second electric motor to thrust the piston 43. Now, the instruction for actuating the first electric motor will be referred to as the “first control instruction”, and the instruction for actuating the second electric motor will be referred to as the “second control instruction”. In S12, the first ECU 10 sets the instruction directed to the first electric motor (an “electric motor 1”) to a value resulting from adding a half (ΔI/2) of the change amount ΔI of the piston thrust force current instruction value to the piston thrust force current instruction value I1 in the previous control period and sets the instruction directed to the second electric motor (an “electric motor 2”) to a value resulting from adding a half (ΔI/2) of the change amount ΔI of the piston thrust force current instruction value to the piston thrust force current instruction value I2 in the previous control period to cause the first electric motor and the second electric motor to thrust the piston 43.

In other words, in S13, the first ECU 10 calculates the first control instruction in the present control period as a sum of the “previous piston thrust force current instruction value I1 of the first electric motor” and a “½ of the change amount ΔI of the piston thrust force current instruction value”, and calculates the second control instruction in the present control period as a sum of the “previous piston thrust force current instruction value I2 of the second electric motor” and a “½ of the change amount ΔI of the piston thrust force current instruction value”. The first ECU 10 (the control portion 10A) outputs the calculated present first control instruction to the electric brake ECU 29 that drives the first electric motor as the instruction directed to the first electric motor, and outputs the calculated present second control instruction to the electric brake ECU 29 that drives the second electric motor as the instruction directed to the second electric motor. After outputting the first control instruction and the second control instruction in the present control period in S13, the first ECU 10 returns. In other words, the first ECU 10 returns to START via END, and repeats the processing in step S1 and the subsequent steps.

On the other hand, if the determination in S12 is “YES”, i.e., the first ECU 10 determines that the change amount ΔI of the piston thrust force current instruction value is equal to or smaller than the first threshold value ΔIthr1, the first ECU 10 proceeds to S14. In this case, the first ECU 10 causes any one of the first electric motor and the second electric motor to thrust the piston 43. In S14, the first ECU 10 calculates the piston thrust force current instruction calculated value I1temp of the first electric motor and the piston thrust force current instruction calculated value I2temp of the second electric motor, hypothetically assuming that the first electric motor is caused to thrust the piston 43. The first ECU 10 calculates I1temp as a sum of the “previous piston thrust force current instruction value I1 of the first electric motor” and the “change amount ΔI of the piston thrust force current instruction value”. The first ECU 10 calculates I2temp as the “previous piston thrust force current instruction value I2 of the second electric motor”.

In S15 subsequent to S14, the first ECU 10 determines whether the first electric motor can be driven. The first ECU 10 makes this determination based on the magnitude of the “difference between I1 temp and I2temp (the absolute value)” and the magnitude of “I1tem”. More specifically, in S15, the first ECU 10 determines whether the difference between I1temp and I2temp is equal to or smaller than the preset second threshold value ΔIthr2 and I1temp is also equal to or smaller than the preset third threshold value I1max. The second threshold value ΔIthr2 can be set based on a design value of, for example, the difference in the piston thrust force current that makes the actuation frequency more even between the first electric motor and the second electric motor. Further, the third threshold value I1max can be set based on a design value of, for example, the piston thrust force current maximum value that can be generated by one of the electric motors.

If the determination in S15 is “YES”, i.e., the first ECU 10 determines that the difference between I1 temp and I2temp is equal to or smaller than the second threshold value ΔIthr2 and I1temp is also equal to or smaller than the third threshold value I1max (the upper limit piston thrust force current instruction value I1 max), the first ECU 10 proceeds to S16. In this case, the first ECU 10 actuates only the first electric motor. In other words, in S16, the first ECU 10 sets the instruction directed to the first electric motor (the “electric motor 1”) to a value resulting from adding the change amount ΔI of the piston thrust force current instruction value to the piston thrust force current instruction value I1 in the previous control period, and sets the instruction directed to the second electric motor (the “electric motor 2”) to the piston thrust force current instruction value I2 in the previous control period. More specifically, in S16, the first ECU 10 calculates the first control instruction in the present control period as a sum of the “previous piston thrust force current instruction value I1 of the first electric motor” and the “change amount ΔI of the piston thrust force current instruction value”, and calculates the second control instruction in the present control period as the “previous piston thrust force current instruction value I2 of the second electric motor”. The first ECU 10 (the control portion 10A) outputs the calculated present first control instruction to the electric brake ECU 29 that drives the first electric motor as the instruction directed to the first electric motor, and outputs the calculated present second control instruction to the electric brake ECU 29 that drives the second electric motor as the instruction directed to the second electric motor. After outputting the first control instruction and the second control instruction in the present control period in S16, the first ECU 10 returns (ends the processing).

On the other hand, if the determination in S15 is “NO”, i.e., the first ECU 10 determines that the difference between I1temp and I2temp is larger than the second threshold value ΔIthr2 or I1temp is larger than the third threshold value I1max (the upper limit piston thrust force current instruction value I1 max), the first ECU 10 proceeds to S17. In this case, the first ECU 10 actuates only the second electric motor. In other words, in S17, the first ECU 10 sets the instruction directed to the first electric motor (the “electric motor 1”) to the piston thrust force current instruction value I1 in the previous control period, and sets the instruction directed to the second electric motor (the “electric motor 2”) to a value resulting from adding the change amount ΔI of the piston thrust force current instruction value to the piston thrust force current instruction value I2 in the previous control period. More specifically, in S17, the first ECU 10 calculates the first control instruction in the present control period as the “previous piston thrust force current instruction value I1 of the first electric motor”, and calculates the second control instruction in the present control period as a sum of the “previous piston thrust force current instruction value I2 of the second electric motor” and the “change amount ΔI of the piston thrust force current instruction value”. The first ECU 10 (the control portion 10A) outputs the calculated present first control instruction to the electric brake ECU 29 that drives the first electric motor as the instruction directed to the first electric motor, and outputs the calculated present second control instruction to the electric brake ECU 29 that drives the second electric motor as the instruction directed to the second electric motor. After outputting the first control instruction and the second control instruction in the present control period in S17, the first ECU 10 returns (ends the processing).

The second embodiment is configured to output the first control instruction and the second control instruction as described above, and basic functions and effects thereof are not especially different from those according to the above-described first embodiment. Especially, in the second embodiment, the first ECU 10 (the control portion 10A) can actuate both the first electric motor and the second electric motor according to, for example, the change amount ΔI of the piston thrust force current value at the present moment. Alternatively, the first ECU 10 (the control portion 10A) can, for example, actuate the first electric motor and also restrict the actuation of the second electric motor according to the change amount ΔI of the piston thrust force current value at the present moment. Alternatively, the first ECU 10 (the control portion 10A) can, for example, actuate the second electric motor and also restrict the actuation of the first electric motor according to the change amount ΔI of the piston thrust force current value at the present moment. As a result, the second embodiment can achieve fine adjustments (fine control) of the thrust force (the piston thrust force) of the piston 43 generated by the first electric motor and the second electric motor, thereby improving the accuracy of controlling the thrust force of the piston 43.

The first embodiment has been described citing the example in which the left front electric brake mechanisms 5L1 and 5L2 and the right rear electric brake mechanism 6R are controlled by the control portion 10A of the first ECU 10, and the right front electric brake mechanisms 5R1 and 5R2 and the left rear electric brake mechanism 6L are controlled by the control portion 11A of the second ECU 11. However, the invention is not limited thereto, and, for example, the right front electric brake mechanisms 5R1 and 5R2 and the left rear electric brake mechanism 6L may be controlled by the control portion 10A of the first ECU 10, and the left front electric brake mechanisms 5L1 and 5L2 and the right rear electric brake mechanism 6R may be controlled by the control portion 11A of the second ECU 11. The same also applies to the second embodiment.

The first embodiment has been described citing the example in which the first thrust member is not actuated (the present state is maintained) as the restriction on the actuation of the first thrust member (the first electric motor 23 and the first piston 26). Further, the first embodiment has been described citing the example in which the second thrust member is not actuated (the present state is maintained) as the restriction on the actuation of the second thrust member (the second electric motor 23 and the second piston 26). However, the invention is not limited thereto, and, for example, the first thrust member may be actuated (thrust) by an actuation amount (a thrust amount) smaller than the second thrust member as the restriction on the actuation of the first thrust member. Further, for example, the second thrust member may be actuated (thrust) by an actuation amount (a thrust amount) smaller than the first thrust member as the restriction on the actuation of the second thrust member. The same also applies to the second embodiment.

The first embodiment has been described citing the example in which this embodiment is configured in such a manner that the first ECU 10 (the control portion 10A) and the electric brake ECUs 29 and 29 of the left front electric brake mechanisms 5L1 and 5L2 are separately provided, and the second ECU 11 (the control portion 11A) and the electric brake ECUs 29 and 29 of the right front electric brake mechanisms 5R1 and 5R2 are separately provided. However, the invention is not limited thereto, and, for example, the functions of the electric brake ECUs 29 and 29 of the left front electric brake mechanisms 5L1 and 5L2 may be included in the first ECU 10 (the control portion 10A). Further, for example, the functions of the electric brake ECUs 29 and 29 of the right front electric brake mechanisms 5R1 and 5R2 may be included in the second ECU 11 (the control portion 11A). The same also applies to the second embodiment.

The first embodiment has been described citing the example in which the left and right front wheel-side electric brake mechanisms 5L1, 5L2, 5R1, and 5R2 are configured to include the first thrust portion (the first electric motor 23 and the first piston 26) and the second thrust portion (the second electric motor 23 and the second piston 26). However, the invention is not limited thereto, and, for example, the left and right rear wheel-side electric brake mechanisms may be configured to include the first thrust portion and the second thrust portion. Alternatively, the left and right front wheel-side electric brake mechanisms and the left and right rear wheel-side electric brake mechanisms may be configured to include the first thrust portion and the second thrust portion. The same also applies to the second embodiment.

The first embodiment has been described citing the example in which the left front wheel-side electric brake mechanisms are configured to include two electric motors as the left front wheel-side electric brake mechanisms by constructing the left front wheel-side electric brake mechanisms 5L1 and 5L2 using the two electric brake mechanisms, i.e., the first left front electric brake mechanism 5L1 and the second left front electric brake mechanism 5L2. However, the invention is not limited thereto, and may be configured to include, for example, three or a larger number of electric motors. In this case, for example, the left front wheel-side electric brake mechanisms may be configured to use a common caliper shared by them or may be configured to include a caliper for each thrust portion (each piston and electric motor). The same also applies to the right front wheel-side electric brake mechanisms, and the same also applies to the second embodiment.

The first embodiment has been described citing the example in which the brake mechanism 21 is a so-called floating caliper-type disk brake configured in such a manner that the pistons 26 are provided on the inner side of the caliper 22A (22A1). However, the invention is not limited thereto, and may be, for example, a so-called opposed piston-type disk brake configured in such a manner that pistons are provided on the inner side and the outer side of the caliper, respectively. The same also applies to the second embodiment.

The first embodiment has been described citing the example in which the control portion is configured in such a manner that the control portion that outputs the first control instruction and the second control instruction is provided to each of the first ECU 10 and the second ECU 11, which are the ECUs for brake control. However, the invention is not limited thereto, and, for example, may be configured to be provided to only any one of the first ECU 10 and the second ECU 11 (i.e., the first ECU 10 or the second ECU 11). Alternatively, for example, the control portion may be configured to be provided to the electric brake ECU 29. Further alternatively, the control portion may be configured to be provided to an ECU other than the ECU for brake control. In other words, the control portion can be configured to be provided to any ECU mounted on the vehicle.

Further, each of the embodiments is merely an example, and it is apparent that the configurations indicated in the different embodiments can be partially replaced or combined.

Possible configurations as the vehicle control apparatus, the vehicle control method, and the vehicle control system based on the above-described embodiments include the following examples.

As a first configuration, a vehicle control apparatus includes a control portion provided to a vehicle including an electric brake mechanism configured to apply a braking force to a wheel of the vehicle by thrusting a thrust portion including a first thrust portion and a second thrust portion controllable independently of each other. The control portion is configured to output a calculation result by making a calculation based on input information. The control portion acquires a target thrust force instruction value to be generated on the thrust portion based on a target braking force to be applied to the wheel, and outputs a first control instruction for actuating the first thrust portion and a second control instruction for actuating the second thrust portion according to a physical amount regarding a change in the target thrust force instruction value.

According to this first configuration, the control portion outputs the first control instruction and the second control instruction according to the physical amount (a change amount, a change rate, a change speed, or the like) regarding the change in the target thrust force instruction value (an instruction value, a current value, an instruction signal, a current signal, or the like for acquiring the target thrust force). Therefore, the control portion can actuate the first thrust portion and the second thrust portion according to the physical amount regarding the change in the target thrust force instruction value at that time. For example, the control portion can “actuate both”, “actuate one and also restrict the actuation of the other”, or “actuate the other and also restrict the actuation of the one” of the first thrust portion and the second thrust portion according to the physical amount regarding the change in the target thrust force instruction value at the present moment. As a result, the vehicle control apparatus can achieve fine adjustments (fine control) of the thrust forces exerted by the first thrust portion and the second thrust portion, thereby improving the accuracy of controlling the thrust forces exerted by the first thrust portion and the second thrust portion.

As a second configuration, in the first configuration, the physical amount regarding the change in the target thrust force instruction value is a change amount of the target thrust force instruction value. According to this second configuration, the control portion outputs the first control instruction and the second control instruction according to the change amount of the target thrust force instruction value. Therefore, the control portion can actuate the first thrust portion and the second thrust portion according to the change amount of the target thrust force instruction value at that time. For example, the control portion can “actuate both”, “actuate one and also restrict the actuation of the other”, or “actuate the other and also restrict the actuation of the one” of the first thrust portion and the second thrust portion according to the change amount of the target thrust force instruction value at the present moment. As a result, the vehicle control apparatus can achieve fine adjustments (fine control) of the thrust forces exerted by the first thrust portion and the second thrust portion, thereby improving the accuracy of controlling the thrust forces exerted by the first thrust portion and the second thrust portion.

As a third configuration, in the second configuration, the control portion outputs the first control instruction and the second control instruction so as to actuate the first thrust portion and also restrict the actuation of the second thrust portion, if the change amount of the target thrust force instruction value is equal to or smaller than a predetermined first threshold value. According to this third configuration, the control portion can actuate the first thrust portion and also restrict the actuation of the second thrust portion when the change amount of the target thrust force instruction value is small. As a result, the vehicle control apparatus can achieve fine adjustments (fine control) of the thrust forces exerted by the first thrust portion and the second thrust portion by prioritizing the actuation of the first thrust portion over the actuation of the second thrust portion while suppressing an increase in the difference between the thrust force of the first thrust portion and the thrust force of the second thrust portion.

As a fourth configuration, in the third configuration, the control portion outputs the first control instruction and the second control instruction so as to actuate only the first thrust portion, if the change amount of the target thrust force instruction value is equal to or smaller than the predetermined first threshold value. According to this fourth configuration, the control portion can actuate only the first thrust portion when the change amount of the target thrust force instruction value is small. As a result, the vehicle control apparatus can achieve fine adjustments (fine control) of the thrust forces exerted by the first thrust portion and the second thrust portion by prioritizing the actuation of the first thrust portion over the actuation of the second thrust portion while suppressing an increase in the difference between the thrust force of the first thrust portion and the thrust force of the second thrust portion.

As a fifth configuration, in the third configuration, the control portion outputs the first control instruction and the second control instruction so as to actuate the first thrust portion and also restrict the actuation of the second thrust portion, if a difference between a first target thrust force instruction value, which is an instruction value of the first thrust portion in the target thrust force instruction value, and a second target thrust force instruction value, which is an instruction value of the second thrust portion in the target thrust force instruction value, is equal to or smaller than a predetermined second threshold value. According to this fifth configuration, the control portion can actuate the first thrust portion and also restrict the actuation of the second thrust portion when the difference between the first target thrust force instruction value and the second target thrust force instruction value is small. As a result, the vehicle control apparatus can achieve fine adjustments (fine control) of the thrust forces exerted by the first thrust portion and the second thrust portion by prioritizing the actuation of the first thrust portion over the actuation of the second thrust portion while suppressing an increase in the difference between the thrust force of the first thrust portion and the thrust force of the second thrust portion.

As a sixth configuration, in the second configuration, the control portion outputs the first control instruction and the second control instruction so as to actuate only the second thrust portion, if the change amount of the target thrust force instruction value is equal to or smaller than the predetermined first threshold value, and a difference between a first target thrust force instruction value, which is an instruction value of the first thrust portion in the target thrust force instruction value, and a second target thrust force instruction value, which is an instruction value of the second thrust portion in the target thrust force instruction value, is also larger than a predetermined second threshold value. According to this sixth configuration, the control portion can adjust the thrust force of the second thrust portion closer to the thrust force of the first thrust portion, the actuation of which is prioritized, by actuating only the second thrust portion when the change amount of the target thrust force instruction value is small and the difference between the first target thrust force instruction value and the second target thrust force instruction value is also large. As a result, the vehicle control apparatus can suppress an increase in the difference between the thrust force of the first thrust portion and the thrust force of the second thrust portion even when the actuation of the first thrust portion is prioritized so as to achieve fine adjustments (fine control) of the thrust forces exerted by the first thrust portion and the second thrust portion.

As a seventh configuration, in the first configuration, the first thrust portion includes a first electric motor, and a first piston configured to be thrust by actuating the first electric motor. The second thrust portion includes a second electric motor, and a second piston configured to be thrust by actuating the second electric motor. According to this seventh configuration, the control portion can, for example, “thrust both” of the first piston and the second piston by “actuating both” of the first electric motor and the second electric motor, “thrust one and also restrict the thrust of the other” of the first piston and the second piston by “actuating one and also restricting the actuation of the other” of the first electric motor and the second electric motor, or “thrust the other and also restrict the thrust of the one” of the first piston and the second piston by “actuating the other and also restricting the actuation of the one” of the first electric motor and the second electric motor according to the physical amount regarding the change in the target thrust force instruction value. As a result, the vehicle control apparatus can improve the accuracy of controlling the thrust forces of the first piston and the second piston generated by the first electric motor and the second electric motor.

As an eighth configuration, in the seventh configuration, the electric brake mechanism includes a caliper configured to press a pair of brake pads against a disk. The electric brake mechanism is configured in such a manner that the second piston is disposed on a rotationally entering side, which is an entrance side of the caliper with respect to a rotational direction of the disk. The electric brake mechanism is configured in such a manner that the first piston is disposed on a rotationally exiting side, which is an exit side of the caliper with respect to the rotational direction of the disk. The physical amount regarding the change in the target thrust force instruction value is a change amount of the target thrust force instruction value. The control portion outputs the first control instruction and the second control instruction so as to actuate the first piston and also restrict the actuation of the second piston, if the change amount of the target thrust force instruction value is equal to or smaller than a predetermined first threshold value. According to this eighth configuration, the control portion can achieve fine adjustments (fine control) of the thrust forces exerted by the first thrust portion and the second thrust portion while prioritizing the thrust of the first piston located on the rotationally exiting side, which is the exit side of the caliper. In this case, the vehicle control apparatus can more effectively reduce the occurrence of noise and a vibration accompanying braking by prioritizing the thrust of the first piston on the rotationally exiting side than when the thrust of the second piston on the rotationally entering side is prioritized.

As a ninth configuration, in the first configuration, the first thrust portion includes a first electric motor, and a piston configured to be thrust by actuating the first electric motor. The second thrust portion includes a second electric motor, and the piston configured to be thrust by actuating the second electric motor. According to this ninth configuration, the control portion can, for example, thrust the piston by “actuating both”, thrust the piston by “actuating one and also restricting the actuation of the other”, or thrust the piston by “actuating the other and also restricting the actuation of the one” of the first electric motor and the second electric motor according to the physical amount regarding the change in the target thrust force instruction value. As a result, the vehicle control apparatus can improve the accuracy of controlling the thrust force of the piston generated by the first electric motor and the second electric motor.

A tenth configuration is a vehicle control method for a vehicle including an electric brake mechanism configured to apply a braking force to a wheel of the vehicle by thrusting a thrust portion including a first thrust portion and a second thrust portion controllable independently of each other. The vehicle control method includes acquiring a target thrust force instruction value to be generated on the thrust portion based on a target braking force to be applied to the wheel, and outputting a first control instruction for actuating the first thrust portion and a second control instruction for actuating the second thrust portion according to a physical amount regarding a change in the target thrust force instruction value.

According to this tenth configuration, the vehicle control method includes outputting the first control instruction and the second control instruction according to the physical amount (a change amount, a change rate, a change speed, or the like) regarding the change in the target thrust force instruction value (an instruction value, a current value, an instruction signal, a current signal, or the like for acquiring the target thrust force). Therefore, the vehicle control method can actuate the first thrust portion and the second thrust portion according to the physical amount regarding the change in the target thrust force instruction value at that time. For example, the vehicle control method can “actuate both”, “actuate one and also restrict the actuation of the other”, or “actuate the other and also restrict the actuation of the one” of the first thrust portion and the second thrust portion according to the physical amount regarding the change in the target thrust force instruction value at the present moment. As a result, the vehicle control method can achieve fine adjustments (fine control) of the thrust forces exerted by the first thrust portion and the second thrust portion, thereby improving the accuracy of controlling the thrust forces exerted by the first thrust portion and the second thrust portion.

As an eleventh configuration, a vehicle control system includes an electric brake mechanism configured to apply a braking force to a wheel of a vehicle by thrusting a thrust portion including a first thrust portion and a second thrust portion controllable independently of each other, and a controller configured to acquire a target thrust force instruction value to be generated on the thrust portion based on a target braking force to be applied to the wheel and output a first control instruction for actuating the first thrust portion and a second control instruction for actuating the second thrust portion according to a physical amount regarding a change in the target thrust force instruction value.

According to this eleventh configuration, the controller outputs the first control instruction and the second control instruction according to the physical amount (a change amount, a change rate, a change speed, or the like) regarding the change in the target thrust force instruction value (an instruction value, a current value, an instruction signal, a current signal, or the like for acquiring the target thrust force). Therefore, the controller can actuate the first thrust portion and the second thrust portion according to the physical amount regarding the change in the target thrust force instruction value at that time. For example, the controller can “actuate both”, “actuate one and also restrict the actuation of the other”, or “actuate the other and also restrict the actuation of the one” of the first thrust portion and the second thrust portion according to the physical amount regarding the change in the target thrust force instruction value at the present moment. As a result, the vehicle control system can achieve fine adjustments (fine control) of the thrust forces exerted by the first thrust portion and the second thrust portion, thereby improving the accuracy of controlling the thrust forces exerted by the first thrust portion and the second thrust portion.

As a twelfth configuration, in the eleventh configuration, the first thrust portion includes a first electric motor, and a first piston configured to be thrust by actuating the first electric motor. The second thrust portion includes a second electric motor, and a second piston configured to be thrust by actuating the second electric motor. According to this twelfth configuration, the controller can, for example, “thrust both” of the first piston and the second piston by “actuating both” of the first electric motor and the second electric motor, “thrust one and also restrict the thrust of the other” of the first piston and the second piston by “actuating one and also restricting the actuation of the other” of the first electric motor and the second electric motor, or “thrust the other and also restrict the thrust of the one” of the first piston and the second piston by “actuating the other and also restricting the actuation of the one” of the first electric motor and the second electric motor according to the physical amount regarding the change in the target thrust force instruction value. As a result, the vehicle control system can improve the accuracy of controlling the thrust forces of the first piston and the second piston generated by the first electric motor and the second electric motor.

As a thirteenth configuration, in the eleventh configuration, the first thrust portion includes a first electric motor, and a piston configured to be thrust by actuating the first electric motor. The second thrust portion includes a second electric motor, and the piston configured to be thrust by actuating the second electric motor. According to this thirteenth configuration, the controller can, for example, thrust the piston by “actuating both”, thrust the piston by “actuating one and also restricting the actuation of the other”, or thrust the piston by “actuating the other and also restricting the actuation of the one” of the first electric motor and the second electric motor according to the physical amount regarding the change in the target thrust force instruction value. As a result, the vehicle control system can improve the accuracy of controlling the thrust force of the piston generated by the first electric motor and the second electric motor.

The present invention shall not be limited to the above-described embodiments, and includes various modifications. For example, the above-described embodiments have been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2020-025080 filed on Feb. 18, 2020. The entire disclosure of Japanese Patent Application No. 2020-025080 filed on Feb. 18, 2020 including the specification, the claims, the drawings, and the abstract is incorporated herein by reference in its entirety.

### REFERENCE SIGNS LIST

1 vehicle
3L left front wheel (wheel)
3R right front wheel (wheel)
5L left front electric brake mechanism
5R right front electric brake mechanism
5L1 first left front electric brake mechanism
5L2 second left front electric brake mechanism
5R1 first right front electric brake mechanism
5R2 second right front electric brake mechanism
10 first ECU (vehicle control apparatus, controller)
10A control portion
11 second ECU (vehicle control apparatus, controller)
11A control portion
21, 41 brake mechanism
22A, 22A1, 22A2, 42 caliper
23 electric motor (first thrust portion, first electric motor, second thrust portion, second electric motor)
26 piston (first thrust portion, first piston, second thrust portion, second piston)
27 brake pad
43 piston (first thrust portion, second thrust portion, piston)
D disk rotor (disk)

1. A vehicle control apparatus comprising:
a control portion provided to a vehicle including an electric brake mechanism configured to apply a braking force to a wheel of the vehicle by thrusting a thrust portion including a first thrust portion and a second thrust portion controllable independently of each other, the control portion being configured to output a calculation result by making a calculation based on input information,
wherein the control portion acquires a target thrust force instruction value to be generated on the thrust portion based on a target braking force to be applied to the wheel, and outputs a first control instruction for actuating the first thrust portion and a second control instruction for actuating the second thrust portion according to a physical amount regarding a change in the target thrust force instruction value.

2. The vehicle control apparatus according to claim 1, wherein the physical amount regarding the change in the target thrust force instruction value is a change amount of the target thrust force instruction value.

3. The vehicle control apparatus according to claim 2, wherein the control portion outputs the first control instruction and the second control instruction so as to actuate the first thrust portion and also restrict the actuation of the second thrust portion, if the change amount of the target thrust force instruction value is equal to or smaller than a predetermined first threshold value.

4. The vehicle control apparatus according to claim 3, wherein the control portion outputs the first control instruction and the second control instruction so as to actuate only the first thrust portion, if the change amount of the target thrust force instruction value is equal to or smaller than the predetermined first threshold value.

5. The vehicle control apparatus according to claim 3, wherein the control portion outputs the first control instruction and the second control instruction so as to actuate the first thrust portion and also restrict the actuation of the second thrust portion, if a difference between a first target thrust force instruction value, which is an instruction value of the first thrust portion in the target thrust force instruction value, and a second target thrust force instruction value, which is an instruction value of the second thrust portion in the target thrust force instruction value, is equal to or smaller than a predetermined second threshold value.

6. The vehicle control apparatus according to claim 2, wherein the control portion outputs the first control instruction and the second control instruction so as to actuate only the second thrust portion, if the change amount of the target thrust force instruction value is equal to or smaller than the predetermined first threshold value, and a difference between a first target thrust force instruction value, which is an instruction value of the first thrust portion in the target thrust force instruction value, and a second target thrust force instruction value, which is an instruction value of the second thrust portion in the target thrust force instruction value, is also larger than a predetermined second threshold value.

7. The vehicle control apparatus according to claim 1, wherein the first thrust portion includes a first electric motor, and a first piston configured to be thrust by actuating the first electric motor, and
wherein the second thrust portion includes a second electric motor, and a second piston configured to be thrust by actuating the second electric motor.

8. The vehicle control apparatus according to claim 7, wherein the electric brake mechanism includes a caliper configured to press a pair of brake pads against a disk,
wherein the electric brake mechanism is configured in such a manner that the second piston is disposed on a rotationally entering side, which is an entrance side of the caliper with respect to a rotational direction of the disk,
wherein the electric brake mechanism is configured in such a manner that the first piston is disposed on a rotationally exiting side, which is an exit side of the caliper with respect to the rotational direction of the disk,
wherein the physical amount regarding the change in the target thrust force instruction value is a change amount of the target thrust force instruction value, and
wherein the control portion outputs the first control instruction and the second control instruction so as to actuate the first piston and also restrict the actuation of the second piston, if the change amount of the target thrust force instruction value is equal to or smaller than a predetermined first threshold value.

9. The vehicle control apparatus according to claim 1, wherein the first thrust portion includes a first electric motor, and a piston configured to be thrust by actuating the first electric motor, and
wherein the second thrust portion includes a second electric motor, and the piston configured to be thrust by actuating the second electric motor.

10. A vehicle control method for a vehicle including an electric brake mechanism configured to apply a braking force to a wheel of the vehicle by thrusting a thrust portion including a first thrust portion and a second thrust portion controllable independently of each other, the vehicle control method comprising:
acquiring a target thrust force instruction value to be generated on the thrust portion based on a target braking force to be applied to the wheel; and
outputting a first control instruction for actuating the first thrust portion and a second control instruction for actuating the second thrust portion according to a physical amount regarding a change in the target thrust force instruction value.

11. A vehicle control system comprising:
an electric brake mechanism configured to apply a braking force to a wheel of a vehicle by thrusting a thrust portion including a first thrust portion and a second thrust portion controllable independently of each other; and
a controller configured to acquire a target thrust force instruction value to be generated on the thrust portion based on a target braking force to be applied to the wheel, and output a first control instruction for actuating the first thrust portion and a second control instruction for actuating the second thrust portion according to a physical amount regarding a change in the target thrust force instruction value.

12. The vehicle control system according to claim 11, wherein the first thrust portion includes a first electric motor, and a first piston configured to be thrust by actuating the first electric motor, and
wherein the second thrust portion includes a second electric motor, and a second piston configured to be thrust by actuating the second electric motor.

13. The vehicle control system according to claim 11, wherein the first thrust portion includes a first electric motor, and a piston configured to be thrust by actuating the first electric motor, and
wherein the second thrust portion includes a second electric motor, and the piston configured to be thrust by actuating the second electric motor.
